(19) United States
(12) Patent Application Publication
(10) Pub. No.: US 2010/0065202 A1
(43) Pub. Date: Mar. 18, 2010

(54) Procedure of Manufacturing a Neutron-Guiding Flat Surface

(76) Inventor: György Kaszás, Budapest (HU)

Correspondence Address: Olson & Cepuritis, LTD., 20 NORTH WACKER DRIVE, 36TH FLOOR, CHICAGO, IL, 60606, US

(21) Appl. No.: 12/226,497

(22) PCT Filed: Apr. 19, 2007
(86) PCT No.: PCT/HU2007/000033

§ 371 Date: Aug. 12, 2009

(30) Foreign Application Priority Data
Apr. 20, 2006 (HU) P0600313

(51) Int. Cl. B29C 65/00

(52) U.S. Cl. 156/285

(57) ABSTRACT

The subject of the invention is a procedure for manufacturing a neutron-guiding flat surface of low waviness in the course of which a thin plate coated by a material suitable for neutron reflection, advantageously of multilayered structure, is glued onto a significantly thicker carrier surface. The procedure is characterised by placing the thin neutron-reflecting plate onto a base surface of low flatness, typically of the order of magnitude of 10⁻⁵ radian, advantageously onto a vacuum table, so that the thin plate lies on the base surface with the neutron-reflecting coating facing the base surface, then the thin plate is positioned on the base surface by means of applying reclining contact points formed along the base edge determined by the size of the thin plate, the thin plate is fixed onto the base surface by means of vacuum suction, then the reclining contacts are removed and a glue is attached to the upper surface of the fixed thin plate which displays low absorption capacity to neutrons and retains its binding strength in the presence of incident neutrons, then the thick carrier plate is stuck to the upper surface of the thin plate by moving the thick plate back and forth thus providing the homogeneous dispersion of the glue, then the thick carrier plate is fixed onto the base surface by reclining points and the binding process of the glue is accelerated by a known and appropriately selected procedure of binding acceleration, then finally the glued plates are removed from the base surface by undoing the reclining points.

The subject of the invention is a procedure for manufacturing a flat surface for constituting the side wall of a multiple-layer neutron guide. In the course of the procedure an appropriate material suitable for reflecting neutrons by means of a neutron-reflecting thin coating, advantageously of multi-layered structure, manufactured by known procedure, is fixed on a base surface of extreme flatness, characteristically better than 10⁻⁵ radian, then a carrier plate—which is significantly thicker than said neutron-reflecting thin plate—is glued to the other side of the neutron-reflecting thin plate, i.e. to the side, which is opposite to the neutron-reflecting layer.

In present-day practice of neutron physics the efficient neutron guides, characterised by low scattering and absorption neutron losses, comprise multi-layered supermirror surfaces. A definite reason of scattering loss is the insufficient flatness of the surface of the guide plane. This feature is regularly improved by the ion-polishing method. Presented e.g. in Physica. B—Condensed Matter vol. 311, (2002) pp. 130-137, by the authors K. Soyama, M. Suzuki, T. Hazawa, A. Moriai, N. Minakawa and Y. Ishii (Center for Neutron Science, Japan Atomic Energy Research Institute, Tokai-mura, Naka-gun, Ibaraki-ken, 319-1195, Japan). Applications of the same procedure were presented in the research reports of Kyoto University Reactor, Japan. This procedure is intended to improve the flatness of a previously manufactured neutron-reflecting surface displaying insufficient flatness. The reported data of neutron loss ratios are more favourable than those obtained with neutron mirrors without the ion-polishing treatment, but the scattering characteristics of the resulting surface are far from optimal in spite of the tremendous cost of the ion-polishing procedure.

The aim of the invention is to create a neutron-guiding supermirror of better surface flatness which provides a higher neutron yield and lower scattering loss. A further aim of the invention is to reduce the manufacturing cost of the neutron-guide compared to that of present neutron guide products.

The thought of the invention is based on the idea of developing a neutron-reflecting surface of similar flatness as the base surface on the inner side of a multilayer coated surface if the neutron-reflecting layer is fixed on the base surface by vacuum suction and in the course of vacuum fixation a carrier plate is glued to the other side of the multilayer coated plate opposite to the neutron-reflecting surface, thus the extremely good surface flatness provided by vacuum suction persists permanently past the binding of the glue and the removal of the vacuum fixing.

Accordingly, a procedure of manufacturing a neutron-guiding flat surface is provided in the course of which a first plate having a neutron reflecting surface is glued to a carrier plate of greater thickness than the first plate, wherein the following steps are performed:
the first plate is placed onto a base surface having a flatness at least in the order of a magnitude of 10⁻⁵ radian in such a way that the neutron-reflecting surface of the first plate lies on the base surface,
the first plate is affixed to the base surface by vacuum suction, and
the carrier plate is glued to the first plate on its surface opposite to the neutron-reflecting surface while the first plate is affixed to the base surface by vacuum suction.

In a preferred embodiment of the invention the first plate is positioned on the base surface before applying vacuum suction by means of reclining contact points formed along a base edge determined by the size of the thin plate, the reclining contact points being removed once the first plate is affixed to the base surface via vacuum suction.

Advantageously, the carrier plate placed onto the first plate is fixed relative to the base surface via the reclining surface while the binding of the glue takes place and after the binding of the glue has taken place the glued plates are removed from the base surface by undoing the reclining contact points.

In an advantageous embodiment of the procedure the first plate bearing the neutron-reflecting layer (advantageously a multilayer coated) on its surface facing the base surface) and fixed to the base surface by vacuum suction has a thickness of 0.5-6 mm and the carrier plate fixed to the back side of the first plate has a thickness of 10-25 mm.

In another advantageous embodiment of the procedure the bulk of the first plate bearing the neutron-reflecting layer is float/borofloat glass and the material of the carrier plate is float/borofloat glass.

In a further advantageous embodiment of the procedure the bulk of the first plate bearing the neutron-reflecting layer is silicon and the material of the carrier plate is borkron glass.

Furthermore, another advantageous embodiment of the procedure is provided when the bulk of the first plate bearing the neutron-reflecting layer is float/borofloat glass and the material of the carrier plate is steel.

In accordance with the aim described above the procedure of the invention—in the course of which a thin plate bearing a layer suitable for neutron reflection, advantageously in the form of a multilayer coating, is glued onto the surface of a carrier plate of significantly greater thickness than that of said thin plate—is accomplished by applying a base surface displaying extreme flatness, advantageously a vacuum table with a flatness typically of the order of magnitude of 10⁻⁵ radian and the thin neutron-reflecting plate is placed onto this base surface so that the neutron reflecting surface of the thin plate lies on the surface of the vacuum table and the thin plate is positioned on the base surface by means of applying reclining contact points formed along the base edge determined by the size of the thin plate, then the thin plate is fixed onto the base surface by vacuum suction and the reclining contacts are removed and a glue is attached to the upper surface of the fixed thin plate which displays low absorption capacity to neutrons and retains its binding strength in the presence of incident neutrons, then the thick carrier plate is stuck to the upper surface of the thin plate by moving the thick plate back and forth thus providing the homogeneous dispersion of the glue, then the thick carrier plate is fixed onto the base surface by reclining points and the binding process of the glue is accelerated by a known and appropriately selected procedure of binding acceleration, then finally the glued plates are removed from the base surface by undoing the reclining points.

The main advantage of the procedure of the invention is that the flatness of the obtained surface of the neutron-guiding supermirror supported by the thicker carrier plate is better than 1.3*10⁻⁴ radian, so the scattering loss of the neutron beam transmitted to the neutron guide is significantly less than that of non-supported neutron guides or neutron guides produced by other procedures.

The thickness of multilayer coated neutron plates (supermirrors) is rather limited owing to the characteristics of the multilayers required for an appropriate reflection angle. Rigidness of these thin plates is low, so an appropriate flatness necessary for providing low absorption and scattering loss is hardly available. The procedure of the invention comprises the step of attaching a thick carrier plate by gluing to the surface of a thin neutron guide plate having a neutron reflecting layer and advantageously formed as a multilayered structure. The thick carrier plate is attached onto the surface opposite to the neutron reflecting surface, while the thin neutron guide plate is affixed by vacuum suction onto an appropriately chosen base surface of great flatness, advantageously a vacuum table, which is equipped with reclining contact points. Thus the reflecting surface of the thin neutron guide plate takes up the flatness of the base surface and retains permanently this feature from this time onwards as it is attached to the rigid carrier plate by gluing.

The procedure of the invention is introduced by an experiment as an example thereof.

### EXAMPLE

The object of the procedure is to attach a thin neutron guide plate of borofloat glass bearing a supermirror plane onto a thick carrier plate of borofloat glass. The size of the selected plates are checked and the parallel shorter sides are set together by a known procedure. A front and rear surfaces of the selected plates are de-fatted by a known cleaning procedure, advantageously by washing with ethanol. Appropriate reclining contact points are formed by means of rapporters and magnetic soles on the surface of the vacuum table which was previously cleaned to dryness and exempted from dust by a known procedure. Contact points located outside the portions to be glued are covered by self-adhesive foil. The cleaned thin glass plate bearing the supermirror or coated plane is placed onto the vacuum table so that its supermirror surface lies on the table surface and its perimeter reclines on the reclining contact points formed on the vacuum table. The glass is reclined from the opposite side. The vacuum pump is switched on after it has been checked for proper functioning so that the thin supermirror-bearing plate is affixed to the vacuum table. After the vacuum fixing the reclining contacts are removed. Loctite UV 349 glue material pre-selected according to its advantageous characteristics for gluing neutron guide plates is put onto the glass surface evenly in 3 mm droplets in a grid of 20 mm distance between the grid points. The thick carrier glass is then placed onto the glued surface. The thick carrier glass is moved back and forth by a quantum of 1-2 mm so the glue is dispersed homogeneously avoiding the formation of air bubbles and the aggregation of the glue. The thick carrier glass is reclined by magnetic soles. It is carefully checked lest the thick carrier glass plate is slid or rotated compared to the thin glass plate. The position of the thick glass plate is checked by a position meter. The attached plates are exposed to the radiation of UV lamp (type F40BLB) intensively for 30 minutes in order to accelerate the binding of the glue. When the binding period elapses the reclining elements are removed then the vacuum is turned off by opening the aeration tap so that the oil vapour of the vacuum pump is exhausted through the tap and does not contaminate the surface of the supermirror. The size of the glued sandwich is controlled with taking special care of the discrepancies potentially caused by sliding. The surface flatness of the glued carrier-supported neutron guide (sandwich glass) is checked by monochromatic light exposure in Ulbricht chamber. After waiting for 15 minutes from switching on the lamp for warming up the sandwich glass is placed onto the standard glass on the bottom of the chamber with the supermirror surface upwards. The dust-free status of the surface is checked, a manual air pump is applied for removing dust particles if necessary. A standard glass of the diameter 70 mm or 300 mm depending on the type of the sandwich and the size of the glued plates, respectively, is placed on to the glass surface. The abundance of interference stripes (Newton ring) is estimated by means of a measuring scale taking care of the homogeneity of the stripe distribution. The measured values are recorded and if they are satisfactory the ready and qualified product is wrapped in smooth filter paper and stored in a horizontal position for further applications.

Neutron guides manufactured according to the procedure of this invention are advantageously applied in equipments of neutron physics making use of neutron beam transmission from the neutron source to the site of application, such as cold neutron sources providing a neutron transport of good efficiency due to low beam loss and of advanced safety due to the lack of radiation damage and activation of the structural materials.

1. Procedure of manufacturing a neutron-guiding flat surface in the course of which a first plate having a neutron reflecting surface is glued to a carrier plate of greater thickness than the first plate characterised by the following steps:
the first plate is placed onto a base surface having a flatness at least in the order of a magnitude of 10⁻⁵ radian in such a way that the neutron-reflecting surface of the first plate lies on the base surface,
the first plate is affixed to the base surface by vacuum suction, and
the carrier plate is glued to the first plate on its surface opposite to the neutron-reflecting surface while the first plate is affixed to the base surface by vacuum suction.

2. Procedure according to claim 1, wherein the first plate has a thickness of 0.5-6 mm and the carrier plate has a thickness of 10-25 mm.

3. Procedure according to claim 1, wherein the first plate is positioned on the base surface before applying vacuum suction by means of reclining contact points formed along a base edge determined by the size of the thin plate, the reclining contact points being removed once the first plate is affixed to the base surface via vacuum suction.

4. Procedure according to claim 3, wherein the carrier plate placed onto the first plate is fixed relative to the base surface via the reclining surface while the binding of the glue takes place and after the binding of the glue has taken place the glued plates are removed from the base surface by undoing the reclining contact points.

5. Procedure according to claim 1, wherein the bulk of the first plate bearing the neutron-reflecting layer is float/borofloat glass and the material of the carrier plate is float/borofloat glass.

6. Procedure according to claim 1, wherein the bulk of the first plate bearing the neutron-reflecting layer is silicon and the material of the carrier plate is borkron glass.

7. Procedure according to claim 1, wherein the bulk of the first plate bearing the neutron-reflecting layer is float/borofloat glass and the material of the carrier plate is steel.
